(19) United States
(12) Patent Application Publication
(10) Pub. No.: US 2015/0324843 A1
(43) Pub. Date: Nov. 12, 2015

(54) System and Method for Capturing, Processing, and Presenting Information

(71) Applicant: Making Everlasting Memories LLC, Cincinnati, OH (US)

(72) Inventors: G. Scott Mindrum, Cincinnati, OH (US); Steven C. Sefton, West Chester, OH (US)

(21) Appl. No.: 14/805,957

(22) Filed: Jul. 22, 2015

Related U.S. Application Data
(63) Continuation of application No. 12/980,806, filed on Dec. 29, 2010.
(60) Provisional application No. 61/291,013, filed on Dec. 30, 2009.

(51) Int. Cl. G06Q 30/02

(52) U.S. Cl. CPC G06Q 30/0251

(57) ABSTRACT

A system and method for capturing, processing, and presenting information includes having customers provide initial information and additional information for use in creating a product for presenting all or a portion of the provided information. A feature of the system and method includes mining the customer-provided information to include other relevant information, not directly supplied by the customer, in the product. A further feature of the system and method includes using the customer-provided information to generate targeted advertising in the form of targeted coupons or other offers for the customer. A further feature of the system and method includes inviting the customers to create an online registry to provide information for use in creating the product.

### PRIORITY

This application is a continuation of U.S. Non-Provisional patent application Ser. No. 12/980,806, filed Dec. 29, 2010, entitled “System and Method for Capturing, Processing, and Presenting Information,” which claims priority to U.S. Provisional Patent Application Ser. No. 61/291,013, filed Dec. 30, 2009, entitled “System and Method for Capturing, Processing, and Presenting Information,” the disclosures of which are incorporated by reference herein.

### BACKGROUND

When a child is born, friends and family members may wish to preserve memories of the child's early development. In addition, when a friend or family member passes away, survivors may wish to preserve memories of the deceased. To that end, it may be desirable to provide a system and method to capture, process, and preserve such information. Examples of ways in which such information may be captured and preserved are disclosed in U.S. Pat. No. 6,340,978, entitled “Method and Apparatus for Recording and Presenting Life Stories,” issued Jan. 22, 2002, the disclosure of which is incorporated by reference herein. While a variety of systems and methods have been made and used to capture, process, and present information, it is believed that no one prior to the inventor(s) has made or used an invention as described herein.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a flow chart of exemplary steps in a process for capturing, processing, and presenting information.

FIGS. 2-13 depict pages of an exemplary first book used in the process for capturing, processing, and presenting information.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

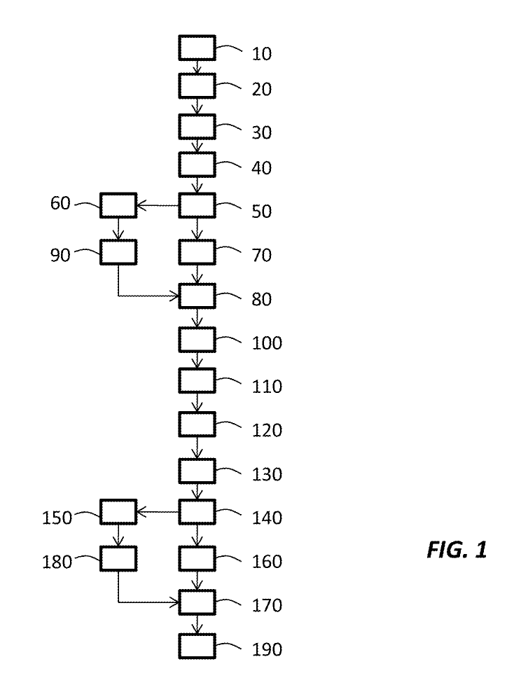

FIG. 1 illustrates exemplary steps that may be carried out as part of a process for capturing, processing, and presenting information. These merely exemplary steps will be discussed in greater detail below. In particular, these exemplary steps will be discussed in the context of information relating to a newborn or otherwise young child. By way of further example only, and not limitation, these merely exemplary steps can, and will from time to time, also be described in the context of information relating to a deceased person. It should be understood, however, that the concepts described herein may be readily applied in a variety of other contexts, and the examples pertaining to newborns, young children, and deceased persons are intended as non-limiting examples. Such other contexts and various ways in which the concepts described herein may be applied in such contexts will be apparent to those of ordinary skill in the art in view of the teachings herein.

The following description will also refer to three categories of parties—namely, an information processor, a product/service provider, and a customer. These terms are used merely for shorthand purposes, and are not intended to limit the scope of the present invention.

An “information processor” is intended to include a broad variety of persons or entities, and may even include several persons or entities in some implementations of the teachings herein. For instance, the information processor may include an entity that is capable of receiving various types of information/content from a customer in various forms (e.g., hard copy, via the internet, etc.); that is able to process such customer-provided information in various ways; and that is able to produce one or more types of products (e.g., books, etc.) that are based at least in part on such customer-provided information. Various types of persons or entities that may fit into the category of “information processor” will be apparent to those of ordinary skill in the art in view of the teachings herein.

A “product/service provider” is intended to include a person or entity that provides products and/or services to customers. In the context of information relating to a child, a “product/service provider” may include a consumer products provider (e.g., manufacturer and/or seller of diapers, baby bottles, other baby-related products, toys, etc.), entities who provide birthing and/or other baby/child-related services, etc. By way of further example only, and not limitation, in the context of information relating to a deceased person, a “product/service provider” may include a cemetery, a funeral home, a headstone provider, etc. Other types of persons or entities that might fit into the category of “product/service provider” will be apparent to those of ordinary skill in the art in view of the teachings herein. It should also be understood that, in some instances, there may be overlap in the roles played by an information processor and a product/service provider. For instance, in some settings, an information processor and a product/service provider may in fact be the same person or entity. As another merely illustrative example, the information processor may work entirely “behind the scenes” from the customer's perspective, such that the product/service provider is the only person/entity that deals directly with the customer.

A “customer” is intended to include a person or entity who submits information that is processed by the information processor and receives at least one product and/or service from the product/service provider. In the context of information relating to a child, a “customer” may include the parents of the child, other family members of the child, or friends of the child's family. By way of further example only, and not limitation, in the context of information relating to a deceased person, a “customer” may include one or more friends or family members of the deceased person. Other types of persons or entities that might fit into the category of “customer” will be apparent to those of ordinary skill in the art in view of the teachings herein.

As shown in FIG. 1, an exemplary process begins in block (10) with a customer being provided with an invitation to participate in the system of the present example. Such an invitation may be provided by the information processor or by the product/service provider. In the context of information relating to a child, the invitation may be provided to the parents or other family members of the child by a doctor's office, by baby-related retailers, at Lamaze classes, at birthing centers, etc. Thus, it should be understood that such an invitation may be provided before the child is even born. By way of further example only, and not limitation, in the context of information relating to a deceased person, the invitation may be provided to friends or family members of a deceased person by a cemetery (e.g., when a cemetery lot is purchased), funeral home (e.g., when pre-need or at-need funeral arrangements are being made), etc.

The invitation in block (10) may take variety of forms. In the context of information relating to a child, the invitation may comprise a coupon booklet with coupons relating to products/services provided by the product/service provider. Such a booklet may include a web address with a promotional code, inviting the customer to create an online account. By way of further example only, and not limitation, in the context of information relating to a deceased person, the invitation may comprise a life pack as described in U.S. Pat. No. 6,340,978, entitled “Method and Apparatus for Recording and Presenting Life Stories,” issued Jan. 22, 2002, the disclosure of which is incorporated by reference herein. For instance, the invitation may comprise a form or questionnaire. Other various forms that invitations of block (10) may take, as well as other ways in which such invitations may be provided to the customer, will be apparent to those of ordinary skill in the art in view of the teachings herein.

With reference to block (20), the customer fills in hard copy or online forms/questionnaires/etc. to provide the information processor and/or the product/service provider with some initial information. Such initial information may relate to the customer and/or to the child or deceased person. The submission of such information by the customer may include the creation of an account with an online system and then providing the information online. In addition or in the alternative, the submission of such information may include filling out a form, questionnaire, other type of “life pack” as mentioned above, etc. In some settings, this initial information is merely textual. In addition or in the alternative, such initial information may include photos, videos, audio, pre-existing documents, etc. Other types of initial information will be apparent to those of ordinary skill in the art in view of the teachings herein.

Block (30) represents the customer returning hard copies (that include initial information) to the information processor and/or the product/service provider. For instance, referring back to the concept of a hard copy “life pack,” this may include mailing back or otherwise delivering a completed life pack to the information processor and/or the product/service provider after the customer has filled in blanks in the life pack in accordance with block (20). In addition or in the alternative, information may be submitted via telephone, via e-mail, and/or in a variety of other ways. Of course, it will also be understood that blocks (20, 30) may be essentially consolidated. For instance, in settings where a customer completes an online form/questionnaire/etc., the customer may simply click on a “send” or “accept” button, etc. to complete the steps represented by blocks (20, 30). Initial information may include a variety of types of information, including but not limited to information about the customer, information about the child or deceased person (e.g., biographical information, etc.), and various other types of information.

Such initial information in the context of blocks (20, 30) may be provided/submitted in a variety of ways. By way of example only, several ways in which such information may be submitted are disclosed in U.S. Pat. No. 6,340,978, entitled “Method and Apparatus for Recording and Presenting Life Stories,” issued Jan. 22, 2002, the disclosure of which is incorporated by reference herein. In addition or in the alternative, initial information may be submitted in accordance with the teachings of U.S. Pat. No. 7,222,120, entitled “Methods of Providing a Registry Service and a Registry Service,” issued May 22, 2007, the disclosure of which is incorporated by reference herein. In addition or in the alternative, including but not limited to when the initial information comprises hard copies of photographs or documents that are being scanned, initial information may be submitted in accordance with the teachings of U.S. Pat. No. 7,657,835, entitled “Method and System for Creating a Commemorative Presentation,” issued Feb. 2, 2010, the disclosure of which is incorporated by reference herein. In addition or in the alternative, including but not limited to when the initial information comprises hard copies of photographs or documents that are being scanned, initial information may be submitted in accordance with the teachings of U.S. Pub. No. 2010/0299621, entitled “System and Method for Extracting a Plurality of Images from a Single Scan,” published Nov. 25, 2010, the disclosure of which is incorporated by reference herein. In addition or in the alternative, initial information may be submitted in accordance with the teachings of U.S. Pub. No. 2008/0005666, entitled “System and Method for Publishing Information and Content,” published Jan. 3, 2008, the disclosure of which is incorporated by reference herein. Still other suitable ways in which a customer may submit initial information to an information processor and/or product/service provider will be apparent to those of ordinary skill in the art in view of the teachings herein.

Block (40) represents the information processor extracting information from the customer's initial submissions. By way of example only, where the customer has filled in a hard copy of a life pack or other type of form/questionnaire/etc. the information processor may enter such information into a database or other computerized storage system. For instance, a human may read the hard copy and manually type the information into the system. In addition or in the alternative, the hard copy may be machine read. As another merely illustrative example, where the customer submits hard copies of photographs or documents that existed before the whole process began (e.g., an ultrasound photograph of a child, etc., or in the context of a deceased person, a copy of an award the deceased person received during their life, etc.), a person working for the information processor may scan such photographs or documents. Still other suitable ways in which information may be extracted from the customer's initial submissions will be apparent to those of ordinary skill in the art in view of the teachings herein. Of course, in settings where the customer submits the initial information online, there may be no need for an additional step of extracting information as represented by block (40).

Block (50) represents further processing of the initial information submitted by the customer. Such processing is carried out by the information processor in the present example. Such further processing may include data mining operations based on the initial information submitted by the customer. For instance, such data mining may be performed in accordance with the teachings of U.S. Pat. No. 6,340,978, entitled “Method and Apparatus for Recording and Presenting Life Stories,” issued Jan. 22, 2002, the disclosure of which is incorporated by reference herein. In addition or in the alternative, such data mining may be performed in accordance with the teachings of U.S. Pub. No. 2008/0005666, entitled “System and Method for Publishing Information and Content,” published Jan. 3, 2008, the disclosure of which is incorporated by reference herein. In the context of information relating to a child, such data mining may include searching for and pulling information about events or facts occurring during a certain time period of the child's life (e.g., at the time the parents learned of the pregnancy, at the time the child was born, etc.). Such data mining may, instead or in addition, include online searching for additional information relating to parents and other family members of the child. By way of further example only, and not limitation, in the context of information relating to a deceased person, such data mining may include searching for and pulling information about historical events or facts that occurred/arose during a certain time period of the deceased person's life, online searching for additional information relating to the deceased person, etc. Other types of processing that may be performed may include the generation of customized text based at least in part on the initial information submitted by the customer. For instance, such an automatically generated customized text may include an automatically generated biography (or partial biography) produced in accordance with the teachings of U.S. Pub. No. 2008/0005666, entitled “System and Method for Publishing Information and Content,” published Jan. 3, 2008, the disclosure of which is incorporated by reference herein.

In some settings, at least part of the initial information may be transmitted to the product/service provider, as represented in block (60). By way of example only, the information processor may transmit the entirety of the initial information to the product/service provider. As another merely illustrative example, the information processor may transmit just a selected portion of the initial information to the product service provider. As yet another merely illustrative example, the information processor may provide a summary or translation of the initial information to the product/service provider. The product/service provider may use such information in a variety of ways, including but not limited to those described in greater detail below. Other various ways in which the product/service provider may use such information will be apparent to those of ordinary skill in the art in view of the teachings herein.

As described in greater detail below, the information submitted by the customer may be used to produce a variety of other types of products. In some settings, the customer is permitted to select the type of product that they will receive, as represented by block (70). By way of example only, various types of products that the customer could select from and that can be based at least in part on information submitted by the customer are disclosed in U.S. Pat. No. 7,671,902, entitled “Image Capture and Distribution System and Method,” issued Mar. 2, 2010, the disclosure of which is incorporated by reference herein. Additional types of products that the customer could select from and that can be based at least in part on information submitted by the customer are disclosed in U.S. Pub. No. 2008/0005666, entitled “System and Method for Publishing Information and Content,” published Jan. 3, 2008, the disclosure of which is incorporated by reference herein. Additional types of products that the customer could select from and that can be based at least in part on information submitted by the customer are disclosed in U.S. Pub. No. 2003/0197721, entitled “Method and System for Creating a Commemorative Presentation,” published Oct. 23, 2003, the disclosure of which is incorporated by reference herein. Other suitable types of products that the customer may be permitted to choose from and that may be based at least in part on information submitted by the customer will be apparent to those of ordinary skill in the art in view of the teachings herein. Alternatively, in some versions the customer simply has no choice of the type of product they will receive.

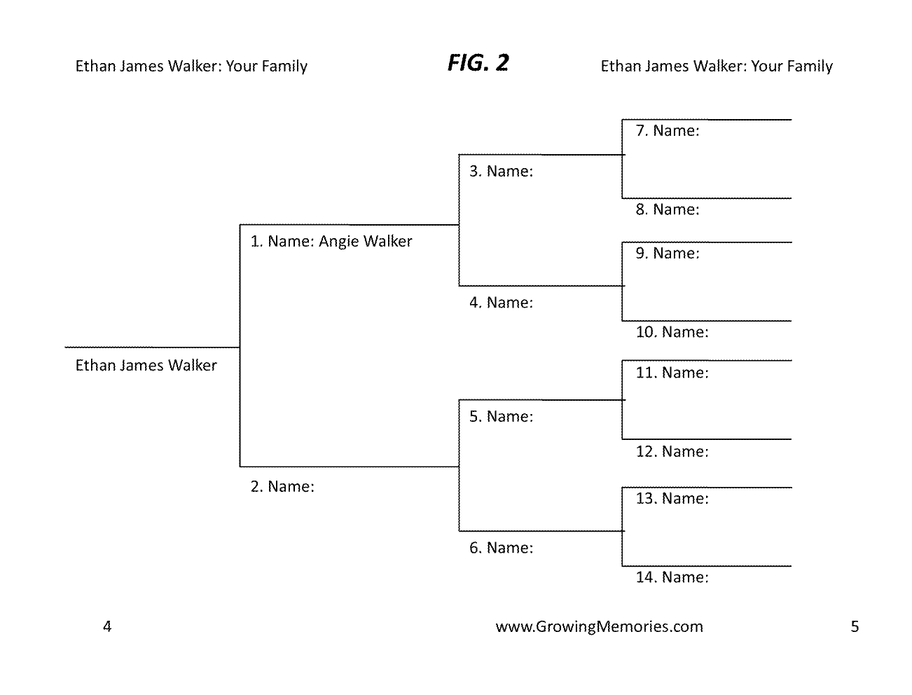

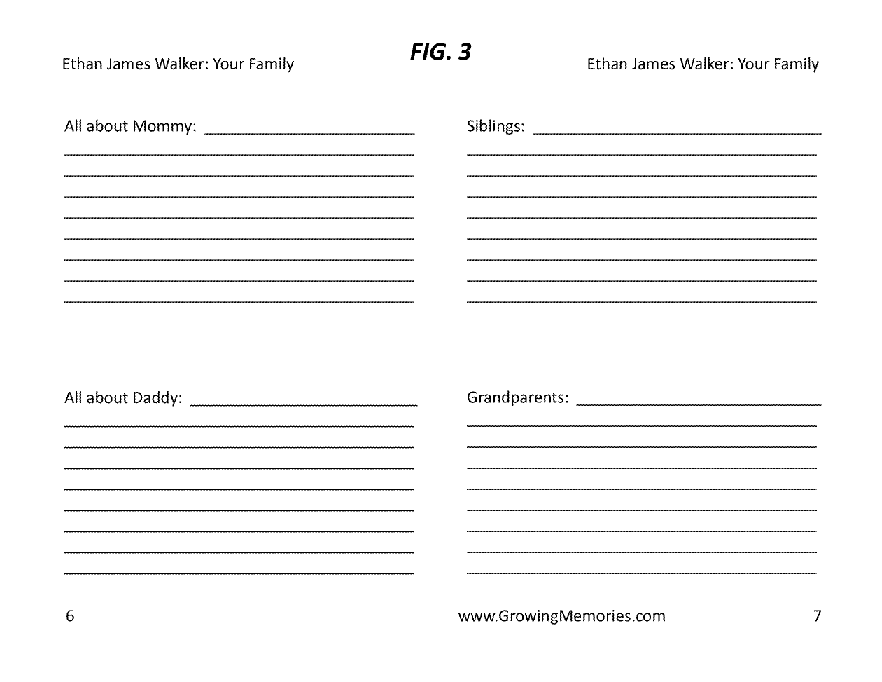

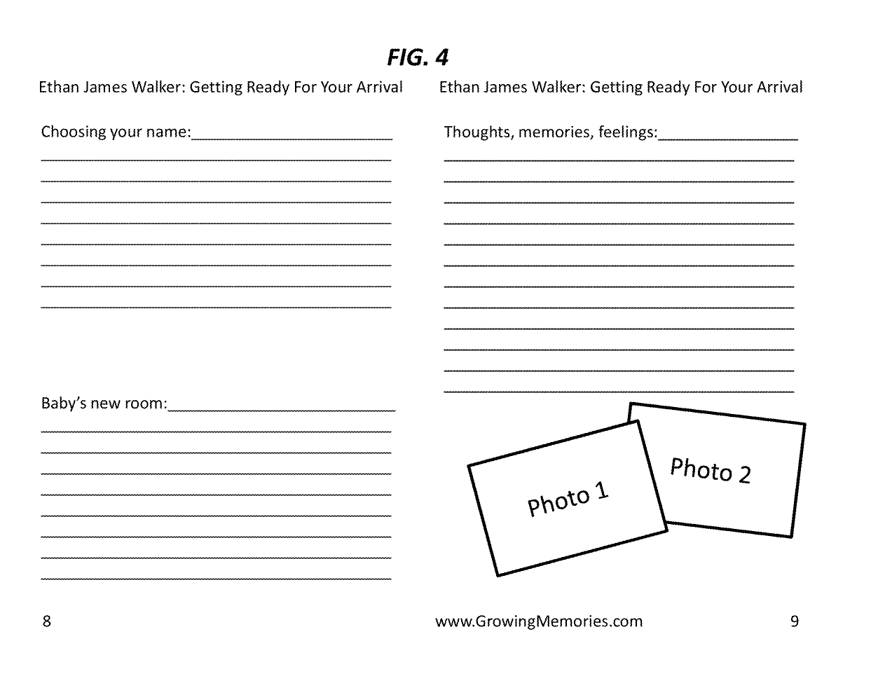

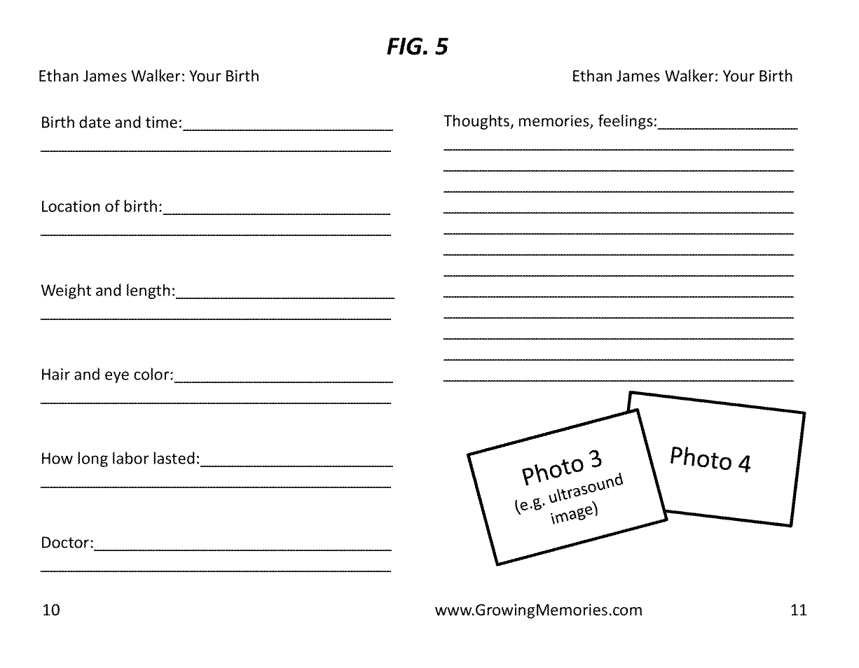

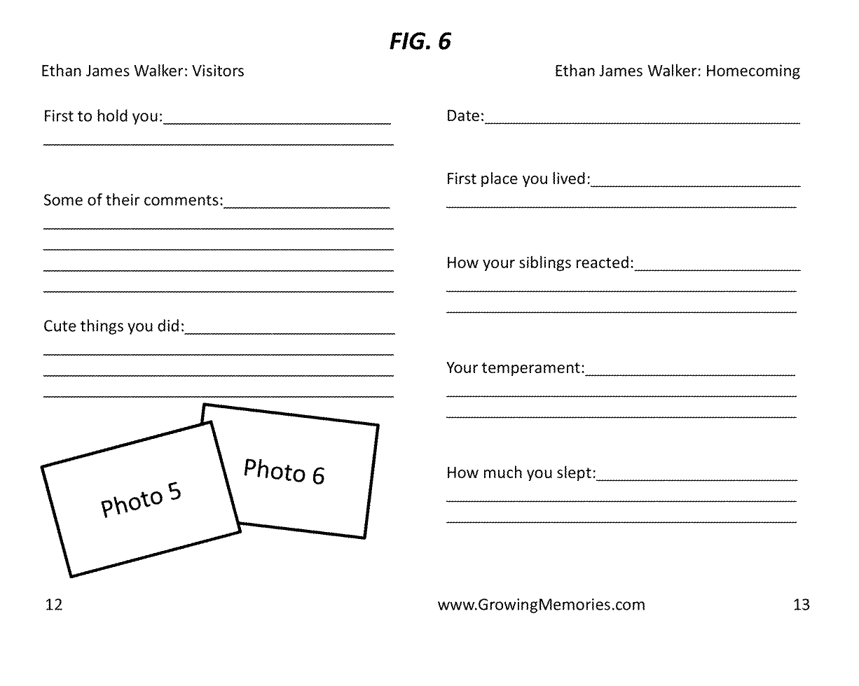

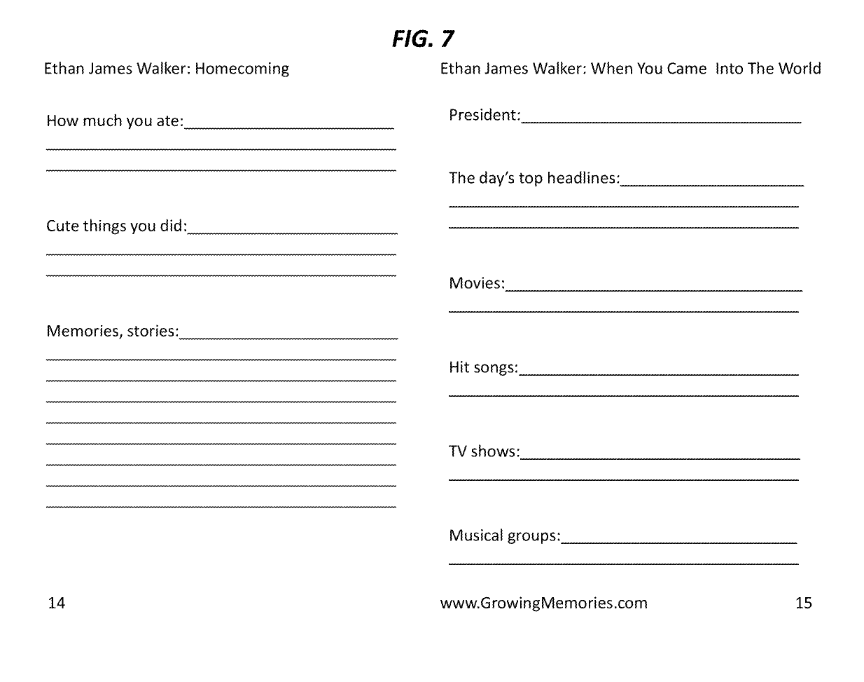

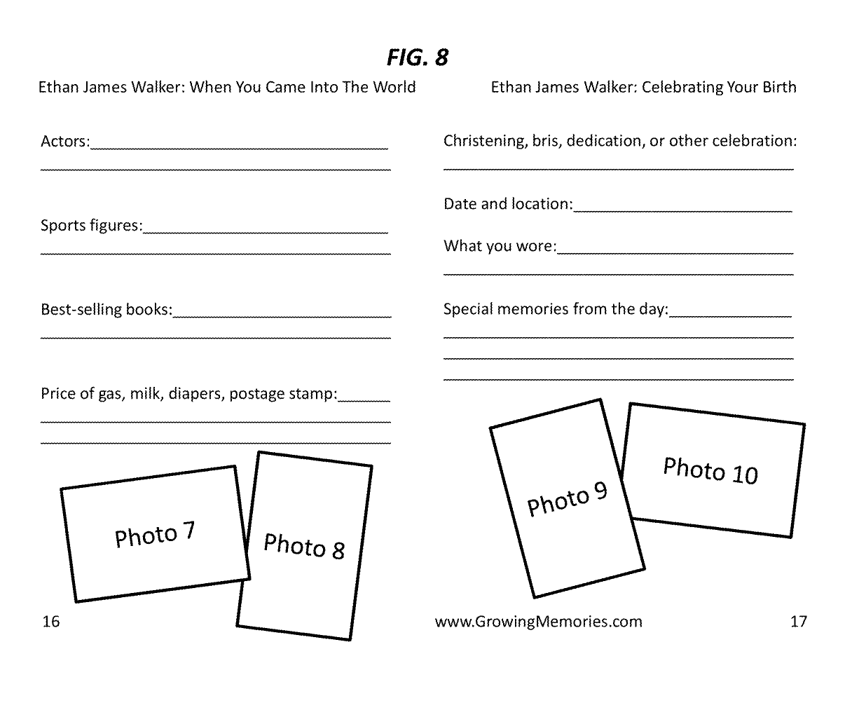

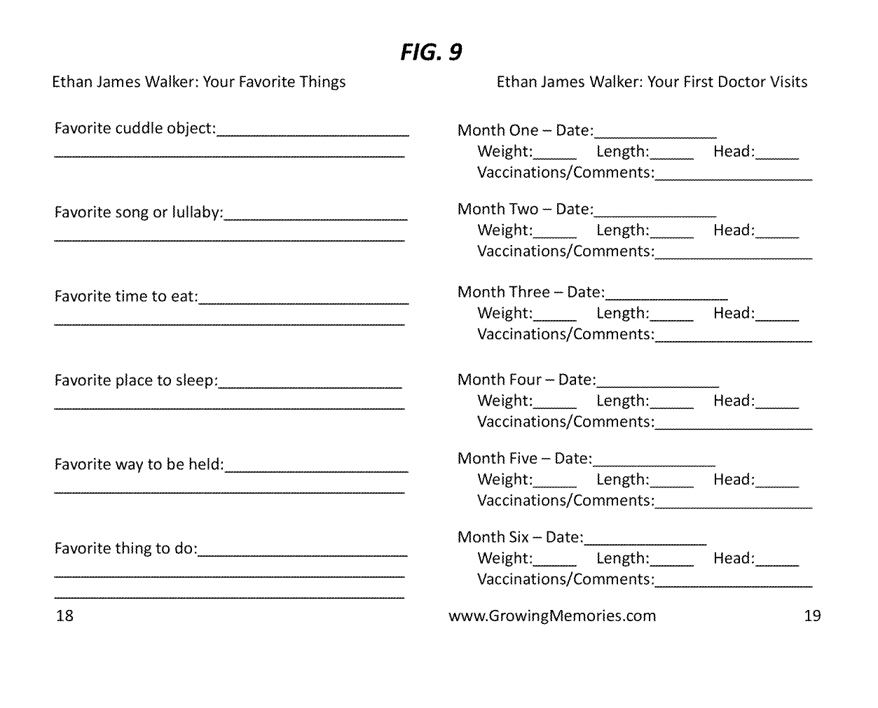

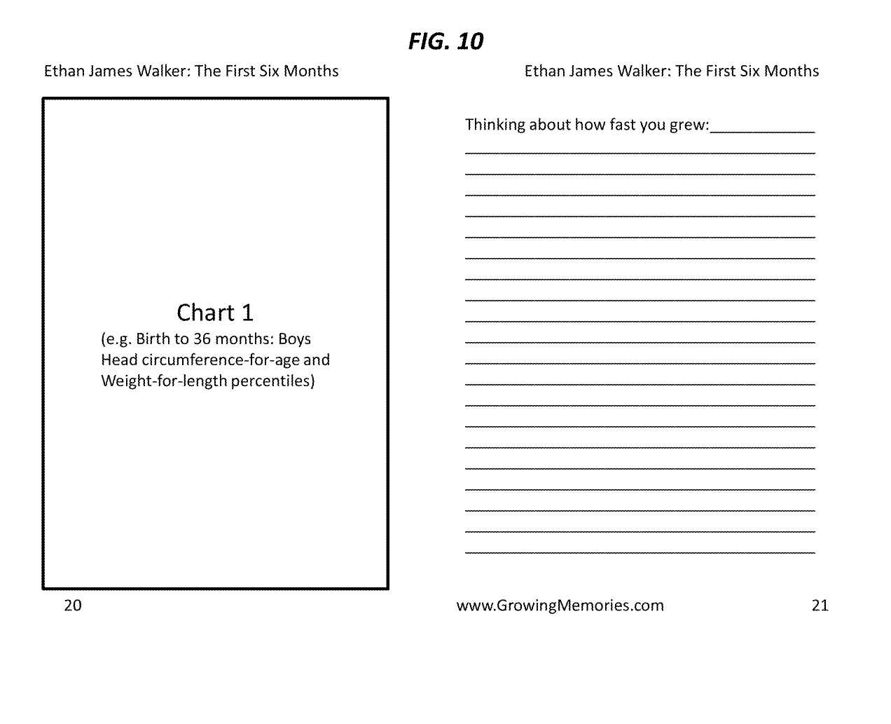

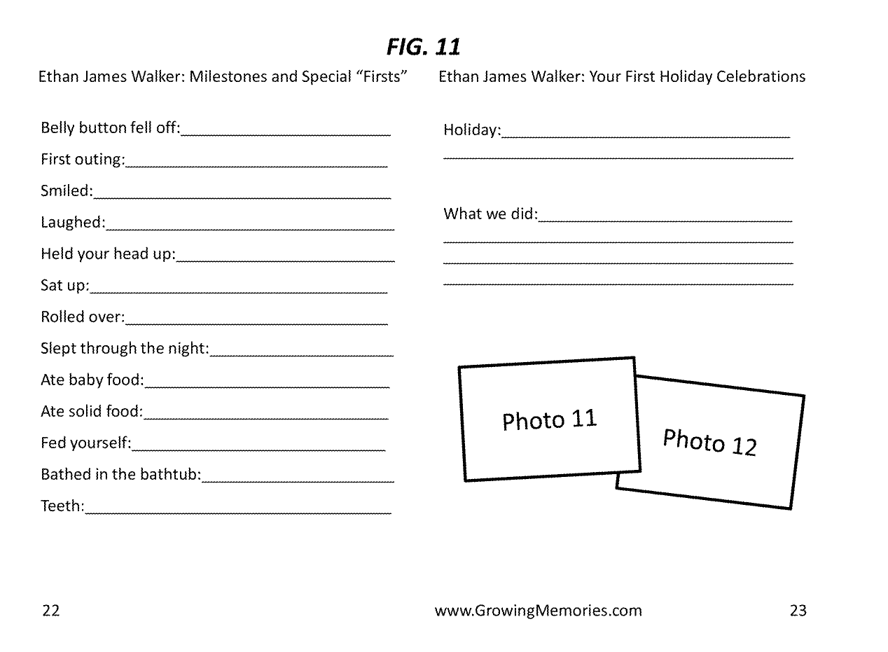

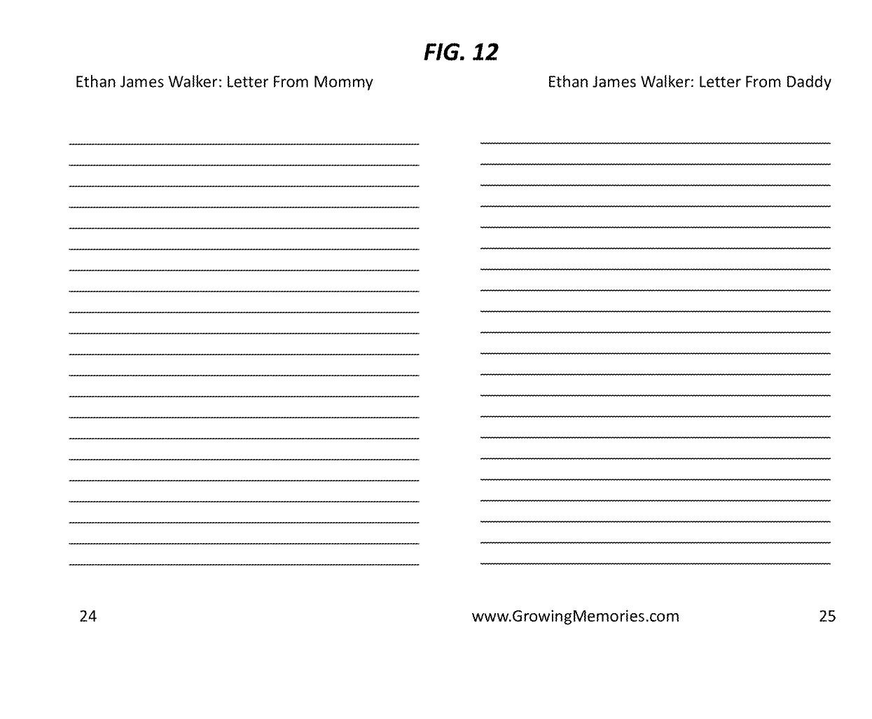

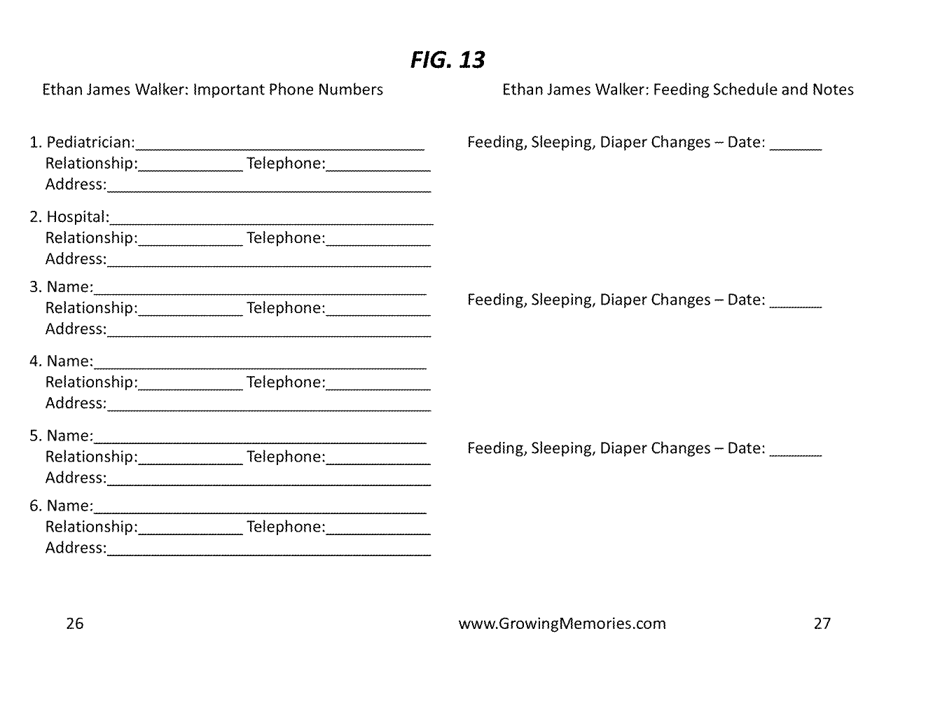

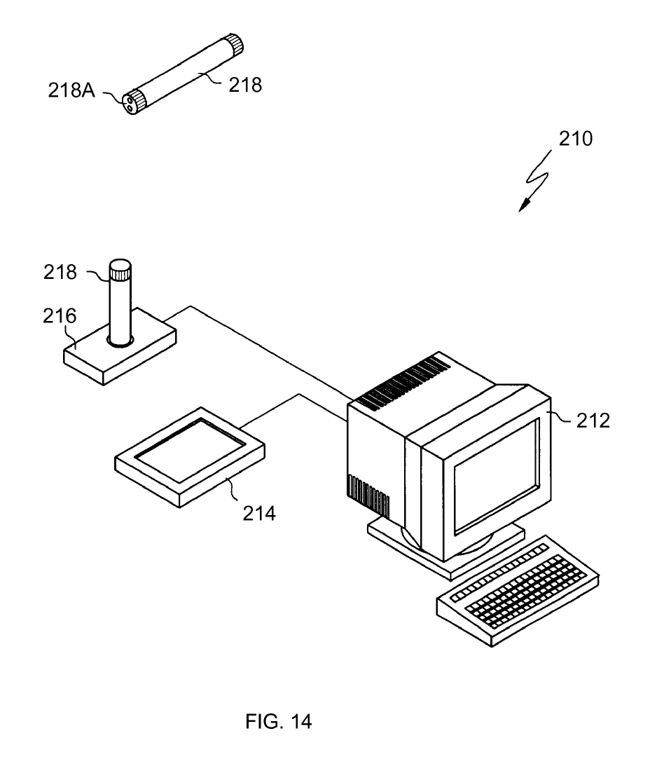

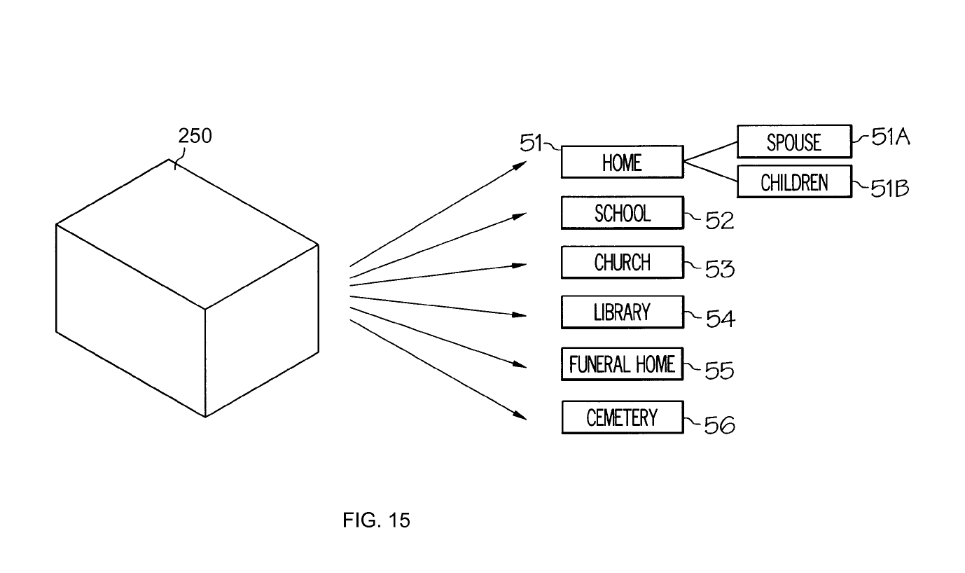

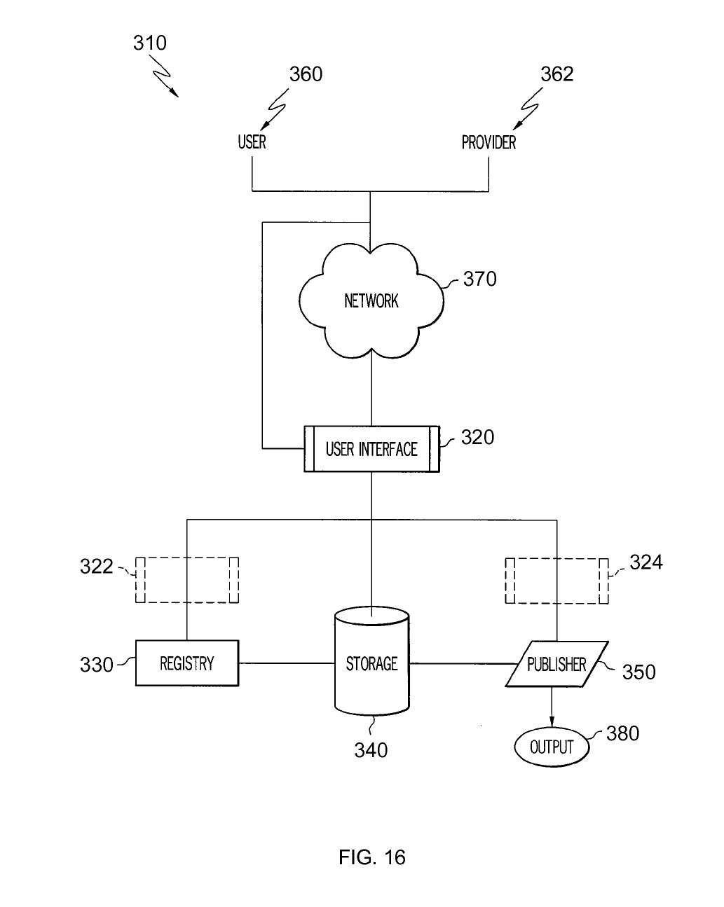

In the present example, the information processor produces a first customized book as a product, as represented by block (80). FIGS. 2-13 are a merely illustrative example of what portions of such a first book may look like in the context of information relating to a child. As shown, this first book includes some information (e.g., photos of the child's mother while she was pregnant with the child, biographical information, etc.) relating to the child (who is named “Ethan James Walker” in this example). This information is based on the initial information provided by the customer as described above. This first book includes an invitation for the customer to create an online account with a registry service (to the extent that the customer had not already created one as part of the steps represented by blocks (20, 30), etc.). In addition, this first book includes several blanks for the customer and other friends and/or family members of the child to fill in. The types of additional information (e.g., family tree information, milestones such as date of first outing, journal entries, memories, etc.) requested by the first book as shown in FIGS. 2-13 are merely exemplary. The first book may request a variety of other types of additional information from the customer and other friends and/or family members of the child. It should also be understood that a variety of types of templates may be used to form the first book. Such templates may be selected in advance by the customer. Alternatively, such templates may be manually or automatically selected by the information processor, based at least in part on the initial information submitted by the customer.

While not specifically shown in FIGS. 2-13, by way of further example only, and not limitation, the first book could be adapted such that the information may relate to subjects other than a newborn or child. For instance, in other contexts the information of the first book could relate to a deceased friend or family member. In view of the teachings herein, other contexts for the information of the first book will be apparent to those of ordinary skill in the art.

The first book whose production is represented by block (80) may be generated in accordance with the teachings of U.S. Pub. No. 2008/0005666, entitled “System and Method for Publishing Information and Content,” published Jan. 3, 2008, the disclosure of which is incorporated by reference herein. In addition or in the alternative, the first book whose production is represented by block (80) may be generated in accordance with the teachings of U.S. Pub. No. 2009/0100369, entitled “Method for Automatically Creating Book Definitions,” published Apr. 16, 2009, the disclosure of which is incorporated by reference herein. Alternatively, the first book whose production is represented by block (80) may be generated in any other suitable fashion.

It should also be understood that, in addition to or in lieu of the first book, a variety of other types of products may be generated based at least in part on the initial information. By way of example only, other types of products that can be produced based at least in part on information submitted by the customer are disclosed in U.S. Pat. No. 7,671,902, entitled “Image Capture and Distribution System and Method,” issued Mar. 2, 2010, the disclosure of which is incorporated by reference herein. Additional types of products that can be produced based at least in part on information submitted by the customer are disclosed in U.S. Pub. No. 2008/0005666, entitled “System and Method for Publishing Information and Content,” published Jan. 3, 2008, the disclosure of which is incorporated by reference herein. Additional types of products that can be produced based at least in part on information submitted by the customer are disclosed in U.S. Pat. No. 7,657,835, entitled “Method and System for Creating a Commemorative Presentation,” issued Feb. 2, 2010, the disclosure of which is incorporated by reference herein. Other suitable types of products that can be produced based at least in part on information submitted by the customer will be apparent to those of ordinary skill in the art in view of the teachings herein.

As noted above with reference to block (60), the information processor may transmit at least some of the initial information submitted by the customer (or a summary/translation/etc. of such information) to the product/service provider. The product/service provider may use such information in a variety of ways. For instance, the product/service provider may use such information for statistical purposes, consumer demographic analysis, etc. In addition or in the alternative, the product/service provider may use such information for targeted advertising. For instance, and as represented by block (90), the product/service provider may use the initial information submitted by the customer to generate coupons that are specifically targeted for the customer. The product/service provider may transmit such targeted coupons to the information processor. The information processor may incorporate such targeted coupons in the first book (e.g., at the end of the first book). In the present example where the first book has information relating to a child, the first book has coupons relating to early child care (e.g., coupons for diapers, etc.). Of course, as with other steps described herein, the targeted coupon generation and transmission step represented by block (90) may be omitted altogether if desired.

With the first book being generated as represented by block (80) and as described above, the first book may be transmitted to the customer as represented by block (100). The first book may be transmitted electronically and/or in hard copy form. In some settings, the information processor transmits the first book directly to the customer. In some other settings, the information processor transmits the first book to the product/service provider, who then provides the first book to the customer. In this way, the information processor may remain entirely or substantially “behind the scenes” from the customer's perspective. In either case, when the first book is delivered to the customer, the customer may again be invited to subscribe to an online registry service. By way of example only, such a registry service may be provided in accordance with the teachings of U.S. Pat. No. 6,340,978, entitled “Method and Apparatus for Recording and Presenting Life Stories,” issued Jan. 22, 2002, the disclosure of which is incorporated by reference herein. In addition or in the alternative, such a registry service may be provided in accordance with the teachings of U.S. Pat. No. 7,222,120, entitled “Methods of Providing a Registry Service and a Registry Service,” issued May 22, 2007, the disclosure of which is incorporated by reference herein. Of course, a registry invitation is merely optional. Furthermore, the customer may already be a subscriber to the registry service at this point anyway (e.g., establishing subscription as part of steps represented by blocks (20, 30), etc.).

As noted above, the first book in the present example shown in FIGS. 2-13 includes blanks for the customer to fill in. The customer fills in these blanks as represented by block (110). In some settings, the customer fills in the blanks by writing directly in the first book (e.g., when the first book is a hard copy). In addition or in the alternative, the customer can fill in blanks in the book electronically. As another merely illustrative example, the first book can be a hard copy including the blanks and some if not all of the same blanks can be filled in electronically, such as through a website. In other words, the customer can fill in the blanks both in their hard copy of the book and online. To the extent that the customer has established a subscription to a related online registry service or other type of related online service, the customer can also submit additional information electronically through such a service. Such additional information may correlate with blanks in the first book and/or may comprise additional information that was not necessarily elicited directly by the first book. By way of example only, additional information submitted by the customer after receipt of the first book may include textual information, audio, video, photos, pre-existing documents, etc.

Block (120) represents the customer returning a filled-in hard copy of the first book. For instance, in cases where the first book comprises a hard copy, the customer may fill in the blanks in the first book and then return the book to the product/service provider or to the information processor. In some settings, the customer is provided with two hard copies of the first book so that they can return one and keep the other. In addition or in the alternative, the customer may simply electronically submit (e.g., online, via the internet) the information elicited by the first book (as well as other additional information) as described above.

To the extent that the customer has submitted the additional information (i.e., information submitted after the customer receives the first book) in hard copy form, the information processor may extract the information from the hard copy/copies, as represented by block (130). To the extent that the hard copy/copies was/were originally sent by the customer to the product/service provider, the product/service provider may transmit such hard copy/copies to the information processor. Such extraction of information may be performed in accordance with the above teachings relating to block (40); or such extraction of information may be performed in any other suitable fashion.

Having received the additional information, the information processor then processes the additional information as represented by block (140). Such further processing may include data mining operations based on the additional information submitted by the customer. For instance, such data mining may be performed in accordance with the teachings of U.S. Pat. No. 6,340,978, entitled “Method and Apparatus for Recording and Presenting Life Stories,” issued Jan. 22, 2002, the disclosure of which is incorporated by reference herein. In addition or in the alternative, such data mining may be performed in accordance with the teachings of U.S. Pub. No. 2008/0005666, entitled “System and Method for Publishing Information and Content,” published Jan. 3, 2008, the disclosure of which is incorporated by reference herein. In the context of information relating to a child, such data mining may include searching for and pulling information about events or facts occurring during a certain time period of the child's life (e.g., at the time the parents learned of the pregnancy, at the time the child was born, etc.). Such data mining may, instead or in addition, include online searching for additional information relating to parents and other family members of the child. By way of further example only, and not limitation, in the context of information relating to a deceased person, such data mining may include searching for and pulling information about historical events or facts that occurred/arose during a certain time period of the deceased person's life, online searching for additional information relating to the deceased person, etc. Other types of processing that may be performed may include the generation of customized text based at least in part on the initial information submitted by the customer. For instance, such an automatically generated customized text may include an automatically generated biography (or partial biography) produced in accordance with the teachings of U.S. Pub. No. 2008/0005666, entitled “System and Method for Publishing Information and Content,” published Jan. 3, 2008, the disclosure of which is incorporated by reference herein.

In some settings, at least part of the additional information may be transmitted to the product/service provider, as represented in block (150). By way of example only, the information processor may transmit the entirety of the additional information to the product/service provider. As another merely illustrative example, the information processor may transmit just a selected portion of the additional information to the product service provider. As yet another merely illustrative example, the information processor may provide a summary or translation of the additional information to the product/service provider. The product/service provider may use such information in a variety of ways, including but not limited to those described herein with reference to block (90). Other various ways in which the product/service provider may use such information will be apparent to those of ordinary skill in the art in view of the teachings herein.

The additional information submitted by the customer may be used to produce a variety of other types of products. In some settings, the customer is permitted to select the type of product that they will receive, as represented by block (160). By way of example only, various types of products that the customer could select from and that can be based at least in part on the additional information (alone or in combination with at least some of the initial information) submitted by the customer are disclosed in U.S. Pat. No. 7,671,902, entitled “Image Capture and Distribution System and Method,” issued Mar. 2, 2010, the disclosure of which is incorporated by reference herein. Additional types of products that the customer could select from and that can be based at least in part on the additional information (alone or in combination with at least some of the initial information) submitted by the customer are disclosed in U.S. Pub. No. 2008/0005666, entitled “System and Method for Publishing Information and Content,” published Jan. 3, 2008, the disclosure of which is incorporated by reference herein. Additional types of products that the customer could select from and that can be based at least in part on the additional information (alone or in combination with at least some of the initial information) submitted by the customer are disclosed in U.S. Pat. No. 7,657,835, entitled “Method and System for Creating a Commemorative Presentation,” issued Feb. 2, 2010, the disclosure of which is incorporated by reference herein. Other suitable types of products that the customer may be permitted to choose from and that may be based at least in part on additional information (alone or in combination with at least some of the initial information) submitted by the customer will be apparent to those of ordinary skill in the art in view of the teachings herein. Alternatively, in some versions the customer simply has no choice of the type of product they will receive. In addition, it should be understood that some versions may permit the customer to receive the type of product only at the block (70) stage, only at the block (160) stage, or only at one or more other stages, etc.

In the present example, the information processor produces a second customized book as a product, as represented by block (170). This second book can include information based on the initial information provided by the customer as described above, and may also be based on the additional information provided by the customer as described above. In the context of information relating to a child, this second book includes some information (e.g., photos of the child as an infant, dates of milestones, etc.) relating to the child (who is again named “Ethan James Walker” in this example). This second book is written as if it were addressed directly to the child, though the second book may alternatively be written in any other suitable style. By way of further example only, and without limitation, in the context of information relating to a deceased person, the second book includes the deceased person's “life story.” In some settings the life story comprises a biography that was automatically generated based at least in part on the initial information and/or the additional information submitted by the customer. Such an automatically generated biography may be produced in accordance with the teachings of U.S. Pub. No. 2008/0005666, entitled “System and Method for Publishing Information and Content,” published Jan. 3, 2008, the disclosure of which is incorporated by reference herein. This exemplary second book also includes photos of the deceased person and their family/friends.

This second book also includes an invitation for the customer to create an online account with a registry service (to the extent that the customer had not already created one, etc.). In addition, this second book includes blanks for the customer and other friends and/or family members of the child to fill in with other information, memories, etc., relating to the child. Of course, such blanks may be omitted and/or other types of information may be elicited by the second book. It should also be understood that a variety of types of templates may be used to form the second book. Such templates may be selected in advance by the customer. Alternatively, such templates may be manually or automatically selected by the information processor, based at least in part on the initial information and/or the additional information submitted by the customer.

In addition to the second book relating to the child, a third book may be created as part of the step represented by block (170). For instance, this third book may more closely resemble the first book. In particular, the second book relating to the child may be created as more of a “keepsake,” while the third book may be created as a vehicle to elicit even more information about the child. It should be understood that this may be desired to capture events, etc. that arose in the child's life after the first set of additional information was submitted by the child's parents/family/etc. Thus, this third book may include more blanks for the customer and other friends and/or family members of the child to fill in. It should also be understood that a variety of types of templates may be used to form the second book and/or the third book. Such templates may be selected in advance by the customer. Alternatively, such templates may be manually or automatically selected by the information processor, based at least in part on the initial information and/or the additional information submitted by the customer.

The second book (and possibly third book) whose production is represented by block (170) may be generated in accordance with the teachings of U.S. Pub. No. 2008/0005666, entitled “System and Method for Publishing Information and Content,” published Jan. 3, 2008, the disclosure of which is incorporated by reference herein. In addition or in the alternative, the second book (and possibly third book) whose production is represented by block (170) may be generated in accordance with the teachings of U.S. Pub. No. 2009/0100369, entitled “Method for Automatically Creating Book Definitions,” published Apr. 16, 2009, the disclosure of which is incorporated by reference herein. Alternatively, the second book (and possibly third book) whose production is represented by block (170) may be generated in any other suitable fashion.

It should also be understood that, in addition to or in lieu of the second book (and possibly third book), a variety of other types of products may be generated based at least in part on the initial information and/or the additional information. By way of example only, other types of products that can be produced based at least in part on the initial information and/or the additional information submitted by the customer are disclosed in U.S. Pat. No. 7,671,902, entitled “Image Capture and Distribution System and Method,” issued Mar. 2, 2010, the disclosure of which is incorporated by reference herein. Additional types of products that can be produced based at least in part on the initial information and/or the additional information submitted by the customer are disclosed in U.S. Pub. No. 2008/0005666, entitled “System and Method for Publishing Information and Content,” published Jan. 3, 2008, the disclosure of which is incorporated by reference herein. Additional types of products that can be produced based at least in part on the initial information and/or the additional information submitted by the customer are disclosed in U.S. Pat. No. 7,657,835, entitled “Method and System for Creating a Commemorative Presentation,” issued Feb. 2, 2010, the disclosure of which is incorporated by reference herein. Other suitable types of products that can be produced based at least in part on the initial information and/or the additional information submitted by the customer will be apparent to those of ordinary skill in the art in view of the teachings herein.

As noted above with reference to block (150), the information processor may transmit at least some of the additional information submitted by the customer (or a summary/translation/etc. of such information) to the product/service provider. The product/service provider may use such information in a variety of ways. For instance, the product/service provider may use such information for statistical purposes, consumer demographic analysis, etc. In addition or in the alternative, the product/service provider may use such information for targeted advertising. For instance, and as represented by block (180), the product/service provider may use the additional information submitted by the customer to generate coupons that are specifically targeted for the customer. The product/service provider may transmit such targeted coupons to the information processor. The information processor may incorporate such targeted coupons in the second book (e.g., at the end of the second book) and/or the third book (if one is produced). In the present example in the context of information related to a child, the second book and/or the third book has coupons relating to early child care (e.g., coupons for diapers, etc.). By way of further example only, and not limitation, in the present example in the context of information related to a deceased person, the second book lacks any such coupons. Of course, as with other steps described herein, the targeted coupon generation and transmission step represented by block (180) may be omitted altogether if desired. It should also be understood that a targeted coupon generation and transmission step may be used in both stages represented by blocks (90, 180); or in just one of the stages represented by blocks (90, 180). Furthermore, as noted below, the process of the customer submitting information and receiving books may be re-iterated several times, particularly in the context of child-related information. Thus, to the extent that a product/service provider receives at least some form of such information, the product/service provider may provide targeted coupons/advertisements for the customer that “evolve” as the child grows up (i.e., the targeted coupons/advertisements change in accordance with the child's increasing age).

With the second book being generated as represented by block (170) and as described above, the second book (and possibly third book) may be transmitted to the customer as represented by block (190). The second book (and possibly third book) may be transmitted electronically and/or in hard copy form. In some settings, the information processor transmits the second book (and possibly third book) directly to the customer. In some other settings, the information processor transmits the second book (and possibly third book) to the product/service provider, who then provides the second book (and possibly third book) to the customer. In this way, the information processor may remain entirely or substantially “behind the scenes” from the customer's perspective. In either case, when the second book (and possibly third book) is delivered to the customer, the customer may again be invited to subscribe to an online registry service. By way of example only, such a registry service may be provided in accordance with the teachings of U.S. Pat. No. 6,340,978, entitled “Method and Apparatus for Recording and Presenting Life Stories,” issued Jan. 22, 2002, the disclosure of which is incorporated by reference herein. In addition or in the alternative, such a registry service may be provided in accordance with the teachings of U.S. Pat. No. 7,222,120, entitled “Methods of Providing a Registry Service and a Registry Service,” issued May 22, 2007, the disclosure of which is incorporated by reference herein. Of course, a registry invitation is merely optional. Furthermore, the customer may already be a subscriber to the registry service at this point anyway (e.g., establishing subscription as part of steps represented by blocks (20, 30), etc.).

As noted above, a third book (or even the second book) may be provided with blanks for the customer to fill in with additional information. This may be particularly applicable in the context of child-related information, as further information may be generated and of interest as the child grows. Thus, at least part of the above-described process (e.g., blocks (110)-(190)) may be re-iterated several times indefinitely, or at least until the child reaches a certain age.

It should be further noted that any of the books provided to the customer can include audio that may be recorded on a chip contained within the book. In some versions this audio can be from a registry of the customer (e.g., a recording uploaded to the registry by the customer of the child's first words, laughter from the child, etc.) In some other versions this audio could be added by either the information processor or product/service provider. In any case, the audio included in the books may be captured in a variety of ways and then subsequently included in the books. For instance, suitable audio may be captured via computer, telephone, some other archived audio source, or other suitable audio capture modes. In view of the teachings herein, various other types of audio and ways to capture and include audio in the books described herein will be apparent to those of ordinary skill in the art.

While the above paragraphs have described the process of FIG. 1 in the context of information related to a child or information related to a deceased person, it should be understood that other contexts are suitable for use with the process of FIG. 1. For instance, any number of contexts where information is provided about a subject with the aim of documenting events as they relate to the subject could be suitable contexts for use with the process of FIG. 1. Furthermore, it should be appreciated that the teachings herein related to the context of information related to a deceased person are merely illustrative, and that the teachings of those examples may be readily applied to the context of information related to a child or in other living contexts.

It should also be understood that any information acquired from the customer as described herein may be archived for the customer. For instance, such archiving may be provided electronically, such that additional persons or entities may have access to at least some of the archived information at a later date.

In addition, in some cases the customer may be the subject of at least some of the submitted information. For instance, in the context of information relating to a child, a parent may have initiated the process shown in FIG. 1. Certain information involved in the process of FIG. 1 as described above may pertain to the parent as the child's mother or father. By way of further example only, and not limitation, in the context of information relating to the deceased person, the deceased person may have at least initiated the process shown in FIG. 1 before the person passed away.

Still other suitable aspects and features that may be provided as part of the process shown in FIG. 1 will be apparent to those of ordinary skill in the art in view of the teachings herein. Similarly, other suitable variations of the process shown in FIG. 1 will be apparent to those of ordinary skill in the art in view of the teachings herein.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

1-20. (canceled)

21. A non-transitory computer readable medium comprising instructions operable to configure a computer to:
a. send an invitation to a customer inviting the customer to participate in creating a first product by providing initial information related to a third party for use in creating the first product;
b. send one or more promotional offers to the customer in exchange for providing the initial information related to the third party;
c. store the initial information related to the third party that is received from the customer in a computerized storage system comprising a database;
d. generate targeted marketing for goods or services for the customer based on the initial information related to the third party that is received from the customer;
e. identify supplemental information by performing acts comprising executing one or more online searches based on the initial information related to the third party that is received from the customer, wherein a portion of the supplemental information is used in creating the first product and in generating the targeted marketing for goods or services for the customer; and
f. send the first product and the targeted marketing to the customer, wherein the targeted marketing accompanies the first product, wherein the first product includes at least a portion of the supplemental information and instructions for submitting additional information for use in creating a second product.

22. The non-transitory computer readable medium of claim 21, wherein the instructions are operable to configure the computer to:
a. store the additional information received from the customer in the computerized storage system;
b. generate additional targeted marketing for goods or services for the customer; and
c. send the second product to the customer.

23. The non-transitory computer readable medium of claim 21, wherein the instructions are operable to configure the computer to identify supplemental information comprising information not directly supplied by the customer.

24. The non-transitory computer readable medium of claim 21, wherein the instructions are operable to configure the computer to determine approved supplemental information comprising the at least a portion of the supplemental information for use in the first product.

25. The non-transitory computer readable medium of claim 21, wherein the first product comprises a first workbook for use documenting early months of a child's life.

26. The non-transitory computer readable medium of claim 25, wherein the second product comprises a memory book keepsake that includes at least some of the information captured in the first workbook.

27. The non-transitory computer readable medium of claim 22, wherein the instructions are operable to configure the computer to send a third product to the customer, wherein the additional targeted marketing accompanies a select one of the second product and the third product, wherein the third product includes instructions for submitting additional information for use in creating a fourth product.

28. The non-transitory computer readable medium of claim 27, wherein the third product comprises a second workbook for use in documenting later months of the child's life.

29. A system comprising:
a. a first computer;
b. a second computer selectively connected to the first computer over a network; and
c. a database accessible by a select one or both of the first computer and the second computer, wherein the database comprises a non-transitory computer readable medium configured to:
i. send an invitation to a customer inviting the customer to participate in creating a first product by providing initial information related to a third party for use in creating the first product,
ii. send one or more promotional offers to the customer in exchange for providing the initial information related to the third party,
iii. store the initial information related to the third party that is received from the customer in a computerized storage system,
iv. generate targeted marketing for goods or services for the customer based on the initial information related to the third party that is received from the customer,
v. identify supplemental information by performing acts comprising executing one or more online searches based on the initial information related to the third party that is received from the customer, wherein a portion of the supplemental information is used in creating the first product and in generating the targeted marketing for goods or services for the customer, and
vi. send the first product and the targeted marketing to the customer, wherein the targeted marketing accompanies the first product, wherein the first product includes at least a portion of the supplemental information and instructions for submitting additional information for use in creating a second product.

30. The system of claim 29, wherein the generated targeted marketing comprises one or more coupons.

31. The system of claim 29, wherein the supplemental information includes notable events related to the initial information related to the third party that is received from the customer.

32. The system of claim 29, wherein the non-transitory computer readable medium is further configured to generate additional targeted marketing for goods or services for the customer based on the additional information received from the customer.

33. They system of claim 29, wherein the invitation provided to the customer includes incentives for the customer providing the initial information.

34. The system of claim 33, wherein the incentives comprises one or more coupons for products or services.

35. The system of claim 29, wherein the invitation further invites the customer to create an online account, wherein the online account is usable to provide a select one or both of the initial and the additional information received from the customer.

36. The system of claim 29, wherein the non-transitory computer readable medium is further configured to receive product selections from the customer, wherein the received product selections select the type of product for the first product and the second product.

37. The system of claim 29, wherein the additional information received from the customer includes one or more photograph images.

38. The system of claim 29, wherein the initial information and the additional information received from the customer relates to a child related to the customer.

39. The system of claim 29, wherein the first product is a first book.
